(19) United States
(12) Patent Application Publication
(10) Pub. No.: US 2024/0327290 A1
(43) Pub. Date: Oct. 3, 2024

(54) SYSTEM AND METHOD FOR CONCRETE REPAIR

(71) Applicant: TERRAFUSE INC., Calgary (CA)

(72) Inventor: Michael Louis BREITHAUPT, Calgary (CA)

(21) Appl. No.: 18/625,696

(22) Filed: Apr. 3, 2024

Related U.S. Application Data
(60) Provisional application No. 63/456,719, filed on Apr. 3, 2023.

(51) Int. Cl. C04B 28/34; C04B 14/04; C04B 14/06; C04B 18/08; C04B 24/38; C04B 40/00; C04B 103/46; C04B 103/54

(52) U.S. Cl. CPC C04B 28/34; C04B 14/045; C04B 14/06; C04B 18/08; C04B 24/383; C04B 40/0042; C04B 2103/46; C04B 2103/54

(57) ABSTRACT

According to an aspect there is provided a package for producing mortar for repairing a surface. The package including a filler, a first binder component comprising a phosphate component, and a second binder component comprising a magnesium oxide component. When mixed with a solvent, the filler, the first binder component, and the second binder component form a mortar for application to a surface. According to further aspects are methods of repairing a surface and methods of manufacturing the package.

### CROSS-REFERENCE TO RELATED APPLICATIONS

This application claims all benefit including priority to U.S. Provisional Patent Application 63/456,719, filed 3 Apr. 2023, and entitled “SYSTEM AND METHOD FOR CONCRETE REPAIR”, the entire contents of which are hereby incorporated by reference herein.

### FIELD

Embodiments of the present disclosure generally relate to the field of construction, and more specifically, embodiments relate to repair concrete and other materials.

### INTRODUCTION

In construction, concrete and/or other construction features sometimes crack and/or become damaged (e.g. surface damage, damage resulting from rebar corrosion and expansion, spalling concrete surfaces, improper pouring and finishing techniques, and the like). One solution when faced with damaged construction features may be to remove the concrete and surrounding structure to fully replace it. Such a solution, however, is often costly and resource intensive (materials, time, and labour). Therefore it may not be desirable to remove and repair damaged concrete in all situations, particularly those where the other damage is relatively minor.

Another solution can be to apply a repair mortar to the cracked or damaged concrete. Repair mortars for concrete are designed to adhere/bond to existing cured concrete structures and surfaces. Repair mortars can be used instead of tearing out old concrete structures, for new surfaces, rebuilding, restoring structural integrity, releveling, etc. Using repair mortars can be much more time and cost effective. However, repair mortars may flake or chip off with weather and normal use. Improvement in the composition and manufacturing of repair mortars is thus desirable.

### SUMMARY

Repair mortars for concrete are designed to adhere/bond to existing cured concrete structures and surfaces. Repair mortars can be used instead of tearing out old concrete structures, for new surfaces, rebuilding, restoring structural integrity, releveling, etc. Using repair mortars can be much more time and cost effective.

For thin overlays, the repair mortars should be designed in a way that allows them to take on the characteristics of the concrete or substrate below. This can ensure that the repair mortar better becomes part of the structure and may better resist flaking or chipping off over time with exposure to weather and normal use.

Portland cement based repair mortars (e.g., those using tricalcium silicate, dicalcium silicate, tricalcium aluminate, and tetra-calcium aluminoferrite) may suffer from a number of drawbacks, including not bonding well to the underlying concrete and flaking and/or chipping off over time. Portland cement based repair mortars can bond mechanically to the existing concrete, but might not bond chemically. As such, Portland cement based repair mortars may need to be modified with polymers (e.g., acrylic polymers) to promote adhesion (i.e., ‘glue’ the repair mortar down to the underlying concrete). These repair mortars can be limited in their application owing to their many operational restrictions (e.g., application thickness, application temperature, water content, concrete preparations).

Magnesium phosphate based repair mortars (sometimes called magnesium potassium phosphate repair mortars) may be able to bond chemically and mechanically to concrete, and a variety of other porous surfaces. The phosphate chemistry can reduce or eliminate the restrictions faced by Portland cement based repair mortars and provide other benefits. However, some drawbacks associated with magnesium phosphate based repair mortars include cure speeds which may be too fast for certain practical applications, an ammonia odour produced during curing, high cost (due to magnesium oxide and/or phosphates being expensive), and the propensity to dry out when thinly applied (resulting in the mortar essentially turning into dusty sand).

Some embodiments described herein can use particle size of the components (e.g., the phosphate component) to improve curing characteristics and physical properties. Some embodiments described herein can provide magnesium phosphate based repair mortars that may be capable of retaining their moisture, controlling the cure times, and/or reducing cost of production. Furthermore, some embodiments described herein may include methods and processes for manufacturing a mixture of powdered reagents that can be combined with a solvent (e.g., water) on site to facilitate manufacturing and/or transportation.

According to an aspect, there is provided a package for producing a mortar. The package including a filler, a first binder component comprising a phosphate component, and a second binder component comprising a magnesium oxide component. When mixed with a solvent, the filler, the first binder component, and the second binder component form a mortar for application to a surface.

According to an aspect, there is provided a method of repairing a surface. The method includes mixing reagents with a solvent to form a mortar and applying the mortar to the surface. The reagents include a filler, a first binder component comprising a phosphate component, and a second binder component comprising a magnesium oxide component.

According to an aspect, there is provided a method of manufacturing mortar reagents. The method includes grinding a first binder component comprising a phosphate component, combining a filler, the first binder component, and a second binder component comprising a magnesium oxide component to form a combination, and mixing the combination. When mixed with a solvent, the combination forms a mortar applicable to defects on a surface.

According to an aspect, there is provided a mixture for repairing a surface, the mixture comprising a filler, a first binder component comprising a phosphate, and a second binder component comprising an alkali earth metal oxide.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 depicts an example method for repairing a defect on a surface using an exemplary repair mortar, according to some embodiments.

FIG. 2 depicts an example method of manufacturing an exemplary product comprising reagents for an exemplary repair mortar, according to some embodiments.

FIG. 3A is a depiction of an example concrete structure in need of repair (302), in accordance with some embodiments.

FIG. 3B is a depiction of the structure of FIG. 3A after an application of a mortar (304), in accordance with some embodiments.

FIG. 4A is a depiction of an example concrete structure in need of repair (402), in accordance with some embodiments.

FIG. 4B is a depiction of the structure of FIG. 4A after an application of a mortar (404), in accordance with some embodiments.

### DETAILED DESCRIPTION

Magnesium phosphate based repair mortars are able to bond chemically and mechanically to concrete, and a variety of other porous surfaces. The phosphate chemistry can reduce or eliminate certain restrictions and challenges associated with, for example, Portland cement based repair mortars, and provide other benefits. An example reaction of a magnesium oxide component with a phosphate component to generate a magnesium phosphate based repair mortar is as follows:

MgO+KH₂PO₄+5H₂O→MgKPO₄·6H₂O (K-struvite) (1)

However, some challenges with magnesium phosphate based repair mortars include cure speeds which may be disadvantageously fast, an ammonia odour which may be produced during curing, high cost (due to magnesium oxide and/or phosphates being expensive), and the propensity to dry out when thinly applied. Excessively fast cure speeds may necessitate fast application once the reagents have been mixed. This can negatively impact the procedure for applying the repair mortar, for example by necessitating the on-site production of several small batches of repair mortar to complete a repair job rather than preparing one larger batch on site or elsewhere to be transported to the site. The ammonia odour arising from using ammonium phosphate may necessitate additional ventilation, limit the locations that the repair mortar can be used, or limit the time a builder can safely work with the repair mortar. Retention of moisture is important to control because it can, in part, determine the working time and slow the curing process. Furthermore, proper moisture retention properties are necessary to ensure that the repair mortar cures properly with the intended strength and mechanical properties. Poor moisture retention can, in some situations, result in a mortar which can turn to a dusty residue that easily separates from the underlying concrete (in some cases, this may occur because the chemical reaction does not occur properly, or does not occur to completion due to lack of available water).

Some embodiments described herein relate to products and methods for producing magnesium phosphate based repair mortars which may be able to improve upon some or all of the challenges listed above. In particular, some embodiments of the products and methods described herein may be useful for increased moisture retention, increased cure times, and/or reduced ammonium odours during curing.

### Magnesium Potassium Phosphate Repair Mortars

According to an aspect, there is provided a magnesium phosphate repair mortar. The repair mortar may include a first binder component comprising a phosphate component having a size distribution, a second binder component comprising a magnesium oxide component, and a filler. In some embodiments, the repair mortar may further include a moisture retention component. In some embodiments, the term “component” may be used to refer to a constituent of the repair mortar in terms of a particular chemical contribution without being specific as to the exact form that component may take. For example, the first binder component may be said to include a phosphate component, and this phosphate component may comprise, for example, a phosphate component.

In some embodiments, a phosphate component is the first component of the binder. Monopostassium phosphate may be well suited as a component of the binder because it may contribute phosphate and potassium to the final repair mortar. Different types of phosphates may also be suitable, such as other dihydrogen phosphate salts (e.g., sodium phosphate) or other phosphates differently protonated (e.g., monohydrogen phosphate salts such as dipotassium monohydrogen phosphate, phosphoric acid, phosphate salts such as tripotassium phosphate). When using other phosphate components, such as dipotassium monohydrogen phosphate, other components may be used to balance the potassium in the reaction, such as magnesium phosphate. When using highly acidic or basic phosphate components, it may be beneficial to control the pH (e.g., by adding buffers or other components to the mixture when preparing the repair mortar). In some embodiments, ammonium phosphate may be used, although it is associated with ammonium odours produced during curing, and as such, other phosphate salts may be preferable.

In some embodiments, a magnesium oxide component is the second component of the binder. In some embodiments, the magnesium oxide component may be magnesium oxide itself. In some embodiments, dead-burned or dead burnt magnesia may be used as the magnesium oxide component. Dead-burned magnesia may be advantageous because it has a reduced reaction rate when compared to certain other magnesium oxide components or compositions, and may therefore provide relatively longer cure times. Different types of magnesium oxide can also be suitable for the repair mortar.

Together, the phosphate component and the magnesium oxide component may be capable of carrying out a reaction similar to that of reaction (1) above. As the first binder component and second binder component react, they may act as a binder to bind each other and any filler in place (i.e., onto the area being repaired). The speed of the reaction (1) may be an important consideration in controlling the cure time of the magnesium phosphate based repair mortar and its physical properties.

In some embodiments, the filler includes sand and/or fly ash. The skilled person would understand that other fillers may be selected. The selection of filler may impact physical properties of the repair mortar such as moisture retention, strength, workability, vertical towelling, etc. In some embodiments, processing the filler, for example in order to provide filler particles of generally even size distribution, or having a size distribution below a predefined particle size threshold, may further enhance the physical properties of the repair mortar.

In some embodiments, fly ash acts as a micro-filler and/or a fluidizer. In some embodiments, this may allow the overall mixture to flow better and/or spread out more easily with less water content required. With Portland cements, as well as magnesium phosphate cements, the ideal or recommended water ratio for stoichiometric purposes may have the effect of making the mortar so dry as to be impractical or unusable. In some embodiments, fly ash may demand lower water content compared to sands (which absorb water and require higher water content). In some embodiments, fly ash may further provide pozzolanic properties (in other words, fly ash may react chemically with, for example, calcium oxide under ordinary conditions to form compounds possessing cementitious properties). In some embodiments, ground glass may be used as a micro-filler and/or fluidizer rather than fly ash. In some embodiments, ground recycled glass may be used as a micro-filled and/or fluidizer.

In some embodiments, the moisture retention component is selected to provide moisture retention to the repair mortar during curing. Retaining moisture may be important not only to increase the amount of time during which the repair mortar is workable, but additionally to generally increase the cure time to possibly provide a more thoroughly reacted repair mortar. In some embodiments, a more thoroughly reacted repair mortar may be characterized by the phosphate component and the magnesium oxide component having had time to fully react while solvated. In some embodiments, the moisture retention component may be a silicate component. In some embodiments, the moisture retention component may be liquid silicate (e.g., a monopotassium silicate component dissolved in water, other phosphate components dissolved in water, or the like). In some embodiments, powdered components (e.g., the filler, and the two binder components) may be mixed into the liquid silicate to generate the repair mortar to be applied to cracks or other damage.

In some embodiments, the repair mortar further comprises cellulosic powder. Cellulosic powder may enhance the moisture retention properties of the repair mortar. In some embodiments, cellulosic powder may provide additional beneficial physical properties to the final repair mortar product, including, but not limited to, increased strength and durability.

In some embodiments, the repair mortar further comprises microfibers. Microfibers may assist in thickening the mortar product, particularly for application. This may contribute to enabling the final repair mortar to be applicable to vertical or overhead surfaces, possibly improving workability and vertical troweling. It will be appreciated by those skilled in the art that repair mortars that may be easily and/or reliably applied to vertical and/or overhead surfaces may be advantageous relative to repairs which cannot—as they can be applied to a wider variety of damaged surfaces and in a wider variety of configurations and situations. Although this disclosure specifically discusses microfibers, it will be appreciated that this is merely an example embodiment and that other thickening agents are contemplated, such as, for example, Bentonite (a finely ground clay substance).

In some embodiments, the repair mortar includes one or more colour powders. Colour powders can be used to tailor the colour of the final product. For example, it may be desirable from an aesthetic perspective to match the colour of the repair mortar with the colour of the underlying concrete. As another example, it may be aesthetically beneficial to contrast the colours of the repair mortar and the underlying surface, so as to highlight or denote where previous cracks or damage have occurred and/or been repaired in the underlying concrete.

In some embodiments, the repair mortar comprises sand, fly ash, potassium phosphate, magnesium oxide, liquid silicate, cellulosic powder, micro-fibers, and colour powders.

According to an aspect, there is provided a package for producing a mortar. The package including a filler, a first binder component comprising a phosphate component, and a second binder component comprising a magnesium oxide component. When mixed with a solvent, the filler, the first binder component, and the second binder component form a mortar for application to a surface.

According to an aspect, there is provided a mixture for repairing a surface, the mixture comprising a filler, a first binder component comprising a phosphate, and a second binder component comprising an alkali earth metal oxide.

### Size Distribution Control

In some embodiments, an important consideration for repair mortars is the size distribution of the phosphate component (e.g., monopotassium phosphate). Varying the size distributions of the phosphate component can result in repair mortars with physical properties, such as strength profile, reaction time (e.g., cure speed), workability, etc. In some embodiments, the size distribution may also be optimized for economic purposes (i.e., to provide suitable physical properties at a lower cost).

In some embodiments, as the phosphate component (e.g., monopotassium phosphate) becomes finer, the cure speed may become slower (i.e. resulting in longer curing times). Thus, increasing the fineness of the phosphate component may be advantageous for increasing the length of the workable time for the repair mortar. This phenomenon may be somewhat unexpected, given that grinding solid components, thereby increasing surface area relative to a solid component, would generally be expected to increase the reaction rate (thereby reducing the curing time). It would not be expected that grinding the phosphate component would result in a slower reaction rate and thus a longer cure time. As described below, in some embodiments, using ground phosphate component may allow for using less phosphate component by weight relative to commercial grade particle sizes of phosphate component.

Furthermore, controlling the reaction time (i.e., cure speed) using the grade of the phosphate component may, in some embodiments, obviate the need for other chemical additives which may otherwise be needed and/or used to chemically slow the cure speed. In some embodiments, limiting the amount of chemical additives may benefit the final repair mortar generated by virtue of at least one of a) reducing the number of components not providing beneficial physical properties, b) reducing the complexity of the final mortar (and potentially reducing the likelihood of detrimental reactions occurring after installation), and/or c) reducing cost of the mortar.

In some embodiments, using finer grain phosphate component may provide a technical benefit of producing a repair mortar using a finer grain phosphate component which has comparable physical properties to a repair mortar which uses a greater amount of coarser grain phosphate component (i.e. which uses more of the phosphate component). For example, the amount of monopotassium phosphate used in the repair mortar in accordance with some embodiments may be reduced from approximately 14% by weight to approximately 11% by weight when using finer particles. In some embodiments, there may not be a significant loss of physical integrity even with the reduction in phosphate component by weight. Thus, decreasing the size of phosphate component particles may be used to generate repair mortars using a lower percentage of phosphate component per unit, which may be economically beneficial.

In some embodiments, increasing the fineness of the phosphate component may allow for a lesser amount of magnesium oxide to be used in the repair mortar compared to embodiments which do not use a ground or finer grain phosphate component. For example, even with the particle size of magnesium oxide remaining unchanged, according to some embodiments, the amount of magnesium oxide can be reduced from approximately 12.5% by weight to 7.5% by weight when using finer particles of phosphate component, without losing significant physical integrity. Thus, this effect may be used to generate comparable repair mortars using a lower quantity of magnesium oxide component per unit than previously required, which may be economically beneficial.

The skilled person will appreciate that there may be a limit wherein at a certain particle size, grinding the phosphate component into even finer powder might not result in beneficial properties, result in less beneficial properties, or even may result in detrimental properties. For example, past a certain threshold of fineness, the chemical reaction may begin to react faster and with increased temperatures, resulting in a mortar which is sticky and harder to work with. In some embodiments, particles finer than about 200 mesh size (meaning 99% of particles pass through the 200 mesh) or finer than 74 microns may no longer provide the beneficial properties.

### Silicates as a Moisture Retention Component

In some embodiments, silicates act as a moisture retention component. As described above, liquid silicate may be used as a moisture retention component. In some embodiments, the liquid silicate may be packaged, stored, and/or transported separately from the powdered reagents. In some embodiments, the use of liquid components may complicate transportation considerations (for example, it may be challenging to transport liquid components in cold climates due to the risk of freezing). Such complications may result in higher expenditures on reagents, labour, and transport logistics, which may lead to higher costs.

In some embodiments, powdered silicates may be useful for providing packages of reagents for the magnesium phosphate repair mortar that can be sold and transported in a single package, and subsequently mixed with a solvent (e.g., water) on-site for application. In some embodiments, potassium silicate powder may form a gel-like substance that may facilitate the mortar retaining moisture after application. In some embodiments, the magnesium phosphate repair mortar reagents (e.g. one or more of the two components of the binder, the filler, and the moisture retention component, and/or any additional components) may be combined into a single package for the user. In some embodiments, potassium silicate powder can react with the water to produce a gel which may reduce the reaction speed, thereby increasing the cure time. Furthermore, potassium silicate may be capable of contributing potassium to the curing reaction. It will be appreciated that although potassium silicate powder is discussed at length, other silicates (e.g., lithium silicate, sodium silicate) are also contemplated for use with various embodiments.

In some embodiments, refining the powder silicate component may obviate the need for a liquid silicate precursor, which may reduce logistical considerations and bottom line costs (e.g., arising from transporting a liquid in freezing temperatures, mixing components in freezing temperatures, and the like). The powder silicate component may also be beneficial in providing more practically useful cure speeds for the reaction (namely those which do not cure too quickly) once the powder silicate component has been mixed with the other components and a solvent (e.g., water). This can further provide the technical advantage of increasing the working time and reducing production costs (e.g., by enabling larger batches to be mixed on site, reducing the amount of time dedicated to mixing the repair mortar, etc.).

In some embodiments, reagents other than potassium silicate power which may create a gel-like reaction may also be suitable for use with embodiments described herein.

In some embodiments, the above-described reagents can be combined into packages for distribution. These packages of powder may provide the technical benefit of being easier to produce, package, and transport. Such packages may also be relatively straightforward to use on-site to prepare the repair mortar, namely by adding water, as compared with existing repair mortars. In some embodiments, the resulting repair mortar after mixing with water may have desirable properties such as one or more of beneficial cure speeds, improved physical and/or structural characteristics, improved moisture retention, and/or lower associated costs.

### Methods of Repairing Materials Using Magnesium Phosphate Based Repair Mortars

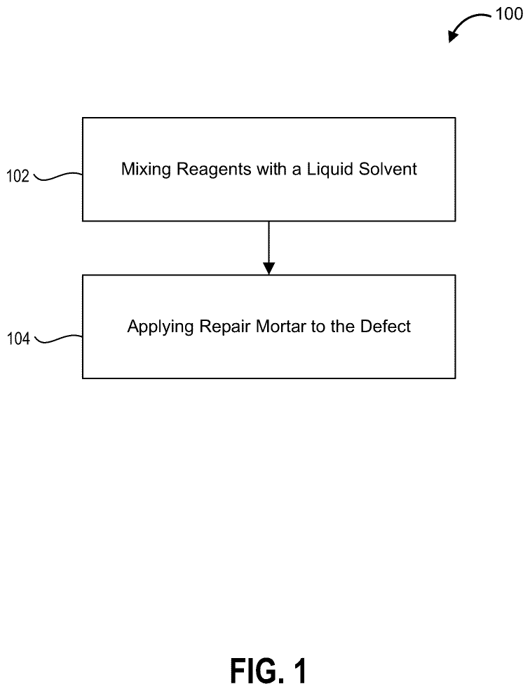

FIG. 1 depicts an example method 100 for repairing a defect on a surface using a repair mortar, according to some embodiments.

At block 102, the reagents may be mixed with a liquid solvent to produce a repair mortar. At block 104, the repair mortar may be applied to a defect.

In some embodiments, the reagents used to form the repair mortar may be provided in a package. In some embodiments, this package may include one or more of powdered components (e.g., a filler, monopotassium phosphate, and magnesium oxide) and liquid components (e.g., a liquid silicate). In such embodiments, the liquid components may be configured to act as the liquid solvent in block 102.

In some embodiments, the package may include only solid and/or powdered components (e.g., a filler, monopotassium phosphate, magnesium oxide, and potassium silicate). In such embodiments, at block 102 a liquid solvent (e.g., water) may be added to the contents of the package. After mixing the reagents with the liquid solvent at block 102, the resulting mortar may be used promptly or after a predetermined amount of time required for the mixture to achieve suitable characteristics. It will be appreciated that the amount of time required will vary depending on the particular type, composition and/or proportions of reagents used.

At block 104, the repair mortar may be applied to a surface. In some embodiments, the repair mortar may be applied within a time period from the initial mixing of the reagents. This time frame may depend at least in part on the curing time of the particular repair mortar. In some embodiments, grinding the phosphate components (e.g., monopotassium phosphate) may beneficially increase the curing time and therefore increase the window in which the repair mortar may be applied.

According to an aspect, there is provided a method 100 of repairing a surface. The method 100 includes mixing reagents with a solvent to form a mortar (102) and applying the mortar to the surface (104). The reagents include a filler, a first binder component comprising a phosphate component, and a second binder component comprising a magnesium oxide component;

### Methods of Manufacturing Packages of Reagents for Magnesium Phosphate Based Repair Mortars

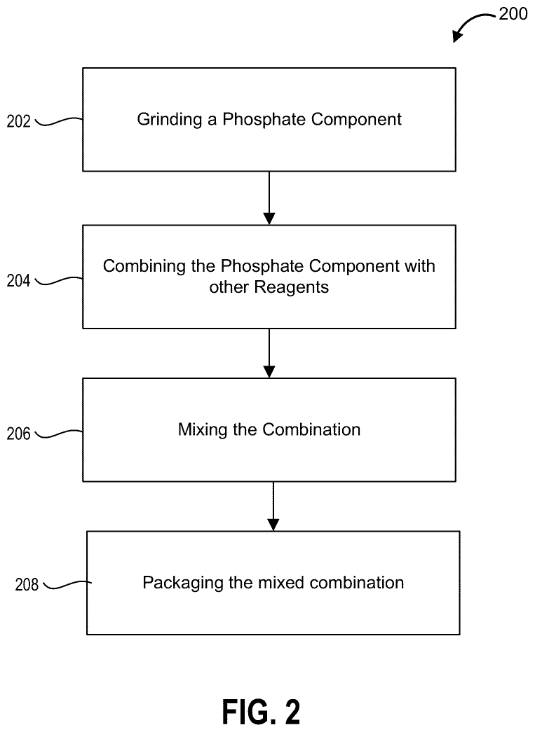

FIG. 2 depicts an example method 200 of manufacturing an exemplary product containing reagents for an exemplary repair mortar, according to some embodiments.

At block 202, a phosphate component may be grinded. In some embodiments, the phosphate component may be grinded until a desired maximum particle size threshold has been attained. At block 204, the ground phosphate component may be combined with other reagents. In some embodiments, the other reagents may include at least one of filler and/or a magnesium oxide component. At block 206, the combination may be mixed. At block 208, the mixed combination may packaged. In some embodiments, reagent packages for magnesium phosphate repair mortars may exhibit beneficial properties, including but not limited to increased curing times.

In some embodiments, block 202 may include passing monopotassium phosphate through a powder grinder. The powder grinder may grind the monopotassium phosphate into a finer powder. In some embodiments, monopotassium phosphate with particle sizes in the range of commercially available vended products may be used. In some embodiments, the particle size may be selected by equipping the powder grinder with a mesh of a particular size to ensure that generally only particles below that mesh size are able to pass through the mesh. In some embodiments the selected mesh size may be between (in standard US mesh) 10 and 500. In some embodiments, the mesh size may be between 20 and 300. In some embodiments, the mesh size is between 20 and 50. In some embodiments, the mesh size is below 50. It will be appreciated that depending on the particular properties desired, other size ranges are contemplated. In some embodiments, meshes may be configured to produce particles with maximum sizes between 300 and 600 microns. In some embodiments, the maximum particle size is 300 microns.

In some embodiments, at block 204, the ground phosphate component may be combined with one or more of the filler, the magnesium oxide component, and any other components (e.g., the moisture retention component). In some embodiments, said other reagents may undergo their own pre-processing steps. In some embodiments, reagents may be combined and mixed in order to prevent clumping.

In some embodiments, at block 206, all ingredients may be added to a dry powder blender for mixing. The reagents may mix easily with little additional effort. Once mixed, at block 208 the mixture may be bagged or otherwise packaged to be sold and/or transported.

In some embodiments, the package produced may comprise powdered components (e.g., a filler, monopotassium phosphate, and magnesium oxide) and liquid components (e.g., a liquid silicate). In such embodiments, the powdered components may be mixed by, for example, performing method 200 and the liquid components may be provided separately. In some embodiments, the package produced may comprise only powdered components (e.g., a filler, monopotassium phosphate, magnesium oxide, and potassium silicate). In such embodiments, all of the components may be mixed by performing method 200.

In some embodiments, the refinement of the raw materials can provide a resulting repair mortar with advantageous characteristics. For example, the monopotassium phosphate component can be ground into a finer powder, which can enable the mixture to use less monopotassium phosphate component and/or less of the magnesium oxide with which the monopotassium phosphate component reacts while still maintaining comparable strength and structural properties. In such embodiments, the mixture may be fabricated more economically due to the use of less monopotassium phosphate and less magnesium oxide.

In some embodiments, the moisture retention component is powdered potassium silicate and may be ground to a fine powder to enhance the cure times and physical characteristics of the final product.

According to an aspect, there is provided a method 200 of manufacturing mortar reagents. The method 200 includes grinding a first binder component comprising a phosphate component (202), combining a filler, the first binder component, and a second binder component comprising a magnesium oxide component to form a combination (204), and mixing the combination (206). When mixed with a solvent, the combination forms a mortar applicable to defects on a surface.

In some embodiments, the combination can then be packaged (208).

### Example Liquid Silicate Embodiments

In some embodiments, the mortar comprises one or more of magnesium oxide, monopotassium phosphate, sand, fly ash, liquid silicate, cellulosic powder, and colouring. In some embodiments, the liquid silicate may be a mixture of potassium silicate and water. In some embodiments, the concentration of potassium silicate may be between 1% to 5%. In some embodiments, the concentration of potassium silicate may be between 2% to 3%. In some embodiments, the concentration of potassium silicate is about 3%. In some embodiments, the curing speed may increase (and therefore the time required for curing may decrease) as the amount of liquid silicate is increased.

### Example Powdered Reagent Embodiments

In some embodiments, the mortar comprises one or more of magnesium oxide, monopotassium phosphate, sand, fly ash, silicate, cellulosic powder, and colouring. In some embodiments, the proportion of magnesium oxide is between 5% and 15%. In some embodiments, the proportion of monopotassium phosphase is between 9% and 15%. In some embodiments, the fineness of monopotassium phosphate is less than 50 mesh. In some embodiments, the proportion of sand is between 50% and 75%. In some embodiments, the proportion of fly ash is between 5% and 25%. In some embodiments, the proportion of silicate is between 1% and 4%. In some embodiments, the proportion of cellulosic powder is between 0.5% and 3%. In some embodiments, the proportion of colour tinting is between 0% and 5%. In some embodiments, the proportion of micro fibers may be 0.4%. In some embodiments, the mortar comprises 7.5% magnesium oxide, 11% monopotassium phosphate (with a fineness of less than 50 mesh), 68% sand, 11% fly ash, 2.5% silicate, 1% cellulosic, and 3% colour tints.

### Applications

Advantages of some embodiments described herein may include one or more of longer working time, fewer or no restrictions on thickness of mortar being applied, lower production costs, safer reagents, increased environmental friendliness, a wider array of possible operating conditions (e.g. usable in freezing temperatures), the ability to apply the mortar vertically or overhead, the ability to be used in forms (which the mortar can be poured into), stampability, colourability, simplicity through a single-component (easier to use), reduced toxic, non-hazardous, improved bonding strength, and/or reduced preparation required for the underlying concrete (e.g., no primers needed). Some embodiments of the repair mortars described herein may be suitable for use with one or more of new surfaces, rebuilding, restoring structural integrity, releveling, or the like.

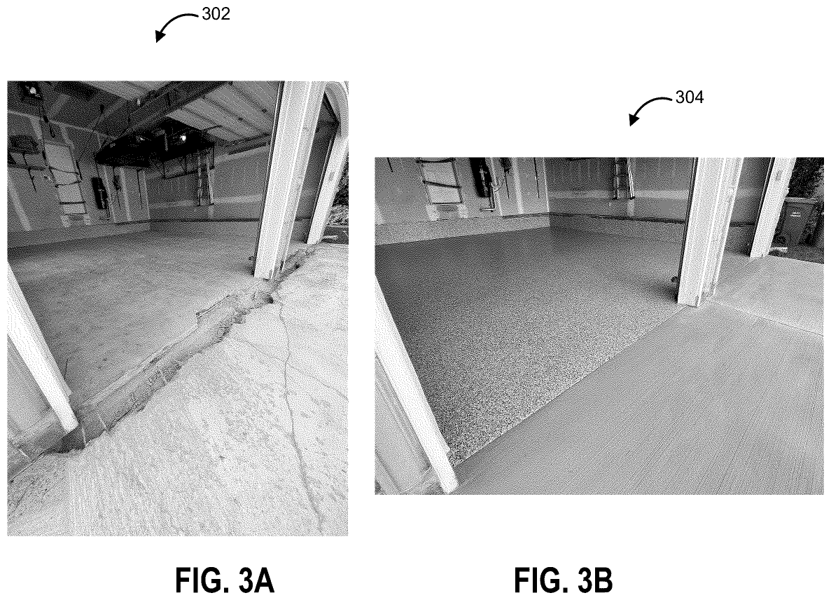

FIG. 3A is a depiction of an example concrete structure in need of repair (302), and FIG. 3B is a depiction of the structure of FIG. 3A after an application of a mortar (304) in accordance with some embodiments.

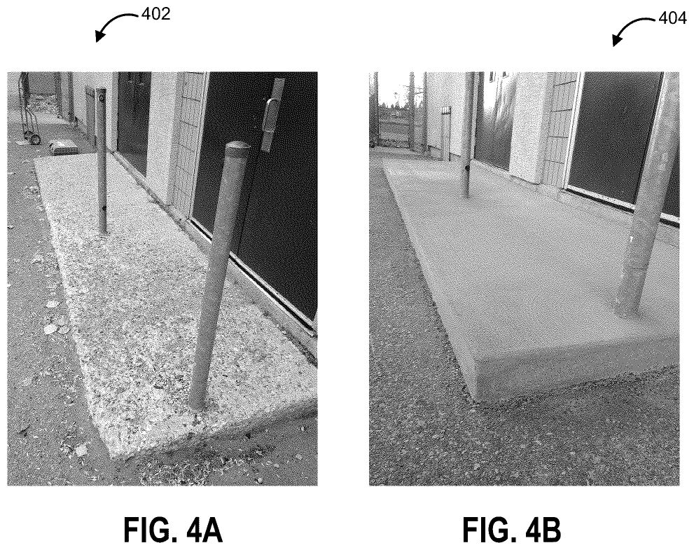

FIG. 4A is a depiction of an example concrete structure in need of repair (402), and FIG. 4B is a depiction of the structure of FIG. 4A after an application of a mortar (404) in accordance with some embodiments.

The products and methods described herein are described in the context of repairing damage to concrete. The skilled person would, however, understand that these products and methods can also be applied in other domains, including but not limited to one or more of ceramics, high temperature casting, molding creation, non-shrink grouting, down-hole cementing, and/or other applications.

It will be appreciated that the embodiments described herein are intended as examples and that the invention is not limited to the specific embodiments described herein. Practical implementation of the features may incorporate a combination of some or all of the aspects, and features described herein should not be taken as indications of future or existing product plans.

Although the embodiments have been described in detail, it should be understood that various changes, substitutions and alterations can be made herein without departing from the scope of the invention. Moreover, the scope of the present invention is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

1. A package for producing a mortar, the package comprising:
a filler;
a first binder component comprising a phosphate component, wherein the phosphate component has a particle size distribution generally below a particle size threshold;
a second binder component comprising an alkali earth metal oxide component; and
wherein, when mixed with a solvent, the filler, the first binder component, and the second binder component form a mortar for application to a surface.

2. The package of claim 1, wherein the alkali earth metal oxide component is a magnesium oxide component.

3. The package of claim 1, wherein the phosphate component comprises monopotassium phosphate.

4. The package of claim 1, wherein the particle size threshold is below of one or more of 600 and 300 microns.

5. The package of claim 1, wherein the second binder component comprises magnesium oxide.

6. The package of claim 1, wherein the second binder component is in powdered form.

7. The package of claim 1, wherein the solvent comprises a moisture retention component.

8. The package of claim 7, wherein the moisture retention component comprises liquid silicate.

9. The package of claim 1, further comprising:
a powdered moisture retention component;
wherein the filler, the first binder component, and the second binder component are powdered; and
wherein the solvent is water.

10. The package of claim 9, wherein the powdered moisture retention component comprises potassium silicate.

11. (canceled)

12. (canceled)

13. A method of repairing a surface, the method comprising:
mixing reagents with a solvent to form a mortar, wherein the reagents comprise:
a filler;
a first binder component comprising a phosphate component, wherein the phosphate component has a particle size distribution generally below a particle size threshold;
a second binder component comprising an alkali earth metal oxide component;
applying the mortar to the surface.

14. The method of claim 13, wherein the alkali earth metal oxide component is a magnesium oxide component.

15. The method of claim 13, wherein the phosphate component comprises monopotassium phosphate.

16. The method of claim 13, wherein the particle size threshold is below of one or more of 600 and 300 microns.

17. The method of claim 13, wherein the second binder component comprises magnesium oxide.

18. The method of claim 13, wherein the second binder component is in powdered form.

19. The method of claim 13, wherein the solvent comprises a moisture retention component.

20. The method of claim 19, wherein the moisture retention component comprises liquid silicate.

21. The method of claim 13, wherein the reagents further comprise:
a powdered moisture retention component;
wherein the filler, the first binder component, and the second binder component are powdered; and
wherein the solvent is water.

22. The method of claim 21, wherein the powdered moisture retention component comprises potassium silicate.

23-57. (canceled)
